(19) United States
(12) Patent Application Publication
(10) Pub. No.: US 2007/0297386 A1
(43) Pub. Date: Dec. 27, 2007

(54) METHOD AND SYSTEM FOR SCHEDULING UPLINK TRANSMISSIONS IN A SINGLE CARRIER FREQUENCY DIVISION MULTIPLE ACCESS SYSTEM

(75) Inventors: Guodong Zhang, Farmingdale, NY (US); Kyle Jung-Lin Pan, Smithtown, NY (US); Allan Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/460,039

(22) Filed: Jul. 26, 2006

Related U.S. Application Data
(60) Provisional application No. 60/703,406, filed on Jul. 28, 2005.

(51) Int. Cl. H04B 7/208

(52) U.S. Cl. 370/344

(57) ABSTRACT

A method and system for scheduling uplink transmissions in a single carrier frequency division multiple access (SC-FDMA) system are disclosed. A Node-B receives a scheduling request from a wireless transmit/receive unit (WTRU). The Node-B selects at least one subcarrier block having a certain bandwidth for the WTRU based on quality of service (QoS) requirement of the WTRU. If the QoS requirement is high, the Node-B selects at least one subcarrier block having a large bandwidth and if the QoS requirement is low, the Node-B selects at least one subcarrier block having a small bandwidth. The Node-B then schedules uplink transmissions in a time domain and/or a frequency domain based on a predetermined factor. The Node-B may perform frequency and/or time hopping in scheduling the uplink transmissions.

### CROSS REFERENCE TO RELATED APPLICATION

This application claims the benefit of U.S. provisional application No. 60/703,406 filed Jul. 28, 2005 which is incorporated by reference as if fully set forth.

### FIELD OF INVENTION

The present invention is related to a wireless communication system. More particularly, the present invention is related to a method and system for scheduling uplink transmissions in a single carrier frequency division multiple access (SC-FDMA) system.

### BACKGROUND

The third generation partnership project (3GPP) and 3GPP2 are currently considering a long term evolution (LTE) of the universal mobile telecommunication system (UMTS) terrestrial radio access (UTRA). Currently, SC-FDMA is being considered for the uplink of the evolved UTRA.

In an SC-FDMA system, data is transmitted simultaneously over a plurality of orthogonal subcarriers, (also referred to as tones, sub-bands or frequencies). The subcarriers are divided into a plurality of subcarrier blocks, (also known as “resource blocks” (RBs)). A subcarrier block may be a localized subcarrier block or a distributed subcarrier block. The localized subcarrier block is a set of consecutive subcarriers, and the distributed subcarrier block is a set of non-consecutive equally-spaced subcarriers.

FIG. 1 illustrates two distributed subcarrier blocks. In this example, the distributed subcarrier block 1 includes subcarriers 1, 5 and 9, and the distributed subcarrier block 2 includes subcarriers 3, 7 and 11. The distributed subcarrier block is a basic scheduling unit for uplink transmissions in a distributed-mode SC-FDMA system. Depending on a data rate or a buffer status, a Node-B assigns at least one distributed subcarrier block for uplink transmissions for a wireless transmit/receive unit (WTRU).

One of the problems in a conventional SC-FDMA system is how to schedule the uplink transmissions to achieve higher throughput and efficient usage of radio resources. Therefore, it is desirable to provide a method and system for efficient scheduling of uplink transmissions in an SC-FDMA system.

### SUMMARY

The present embodiments are related to scheduling uplink transmissions in an SC-FDMA system. A Node-B receives a scheduling request from a WTRU. The Node-B selects at least one subcarrier block having a certain bandwidth for the WTRU based on quality of service (QoS) requirement of the WTRU. If the QoS requirement, (for example, data rate), is high, the Node-B selects at least one subcarrier block having a large bandwidth and if the QoS requirement is low, the Node-B selects at least one subcarrier block having a small bandwidth. The Node-B then schedules uplink transmissions in a time domain and/or a frequency domain based on a predetermined factor. The Node-B may perform frequency and/or time hopping scheduling for the uplink transmissions of WTRU.

### BRIEF DESCRIPTION OF THE DRAWINGS

FIG. 1 shows distributed subcarrier blocks in a conventional distributed-mode SC-FDMA system.

FIG. 2 is a flow diagram of a process for scheduling uplink transmissions in an SC-FDMA system.

FIG. 3 is a block diagram of a Node-B.

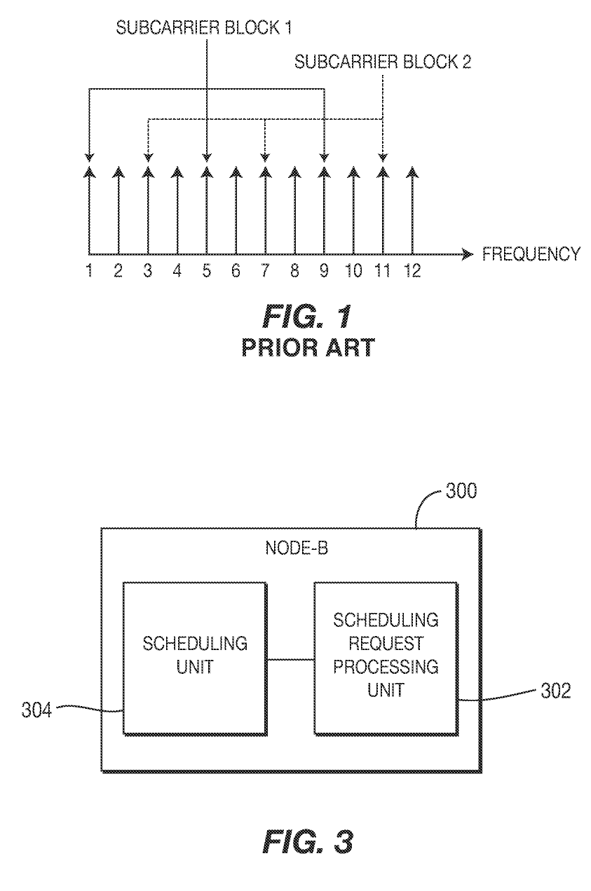

### DETAILED DESCRIPTION OF THE PREFERRED EMBODIMENTS

When referred to hereafter, the terminology “WTRU” includes, but is not limited to, a user equipment (UE), a mobile station (STA), a fixed or mobile subscriber unit, a pager, or any other type of device capable of operating in a wireless environment. When referred to hereafter, the terminology “Node-B” includes, but is not limited to, a base station, a site controller, an access point or any other type of interfacing device in a wireless environment.

The features of the present embodiments may be incorporated into an integrated circuit (IC) or be configured in a circuit comprising a multitude of interconnecting components.

The present embodiments provide for scheduling uplink transmissions in an SC-FDMA system. Scheduling is performed based on the trade-off between the performance of the wireless communication system and a signaling overhead. The scheduling scheme achieves efficient usage of radio resources.

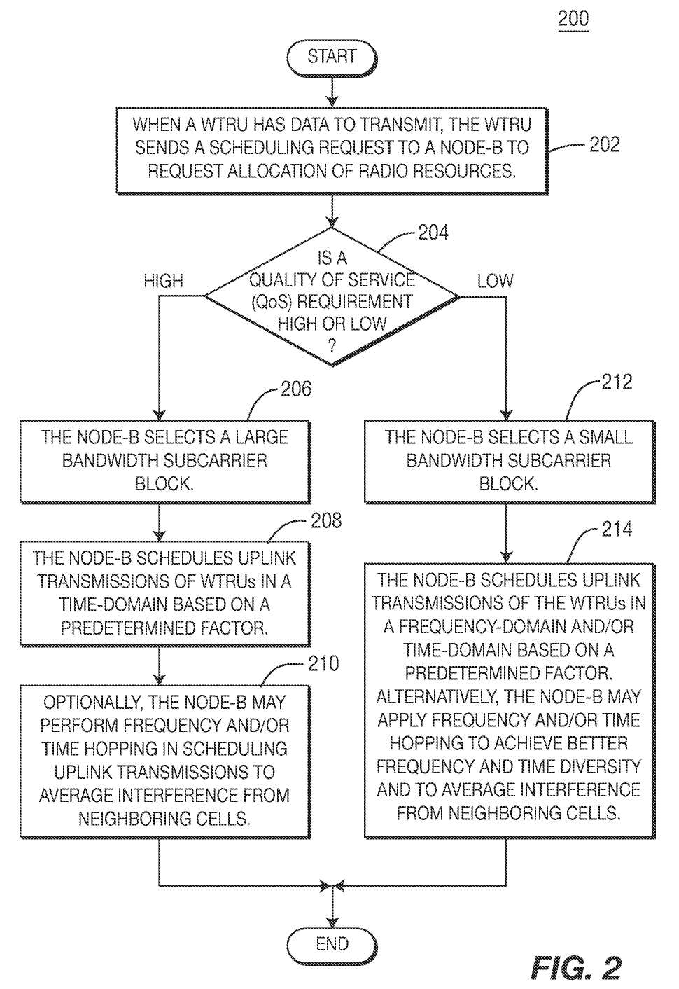

FIG. 2 is a flow diagram of a process 200 for scheduling uplink transmissions in an SC-FDMA system. When a WTRU has data to transmit, the WTRU sends a scheduling request to a Node-B to request allocation of radio resources, (i.e., one or several localized or distributed subcarrier blocks) (step 202). Upon receipt of the scheduling request, the Node-B determines whether a quality of service (QoS) requirement, (e.g., a data rate requirement), of the WTRU is high or low (step 204).

The bandwidth of the distributed or localized subcarrier block, (i.e., the number of subcarriers in one subcarrier block), to be assigned to the WTRU is adaptively selected based on the QoS requirement and other parameters of the WTRU. For a WTRU with a high QoS requirement, at least one large bandwidth, (distributed or localized), subcarrier block, (i.e., a subcarrier block including a large number of equally spaced subcarriers), is selected and for a WTRU with a low QoS requirement, at least one small bandwidth, (distributed or localized), subcarrier block, (i.e., a subcarrier block including a small number of equally spaced subcarriers), is selected.

If it is determined that the QoS requirement is high, the Node-B selects a large bandwidth subcarrier block for the WTRU (step 206). The Node-B then schedules uplink transmissions of WTRUs in a time-domain based on a predetermined factor (step 208). In this case, it is not necessary to perform frequency-domain channel dependent scheduling, since enough frequency diversity is achieved by utilizing the large bandwidth subcarrier block. Frequency-domain scheduling will not provide much improved performance considering the cost of signaling overhead for the scheduling information.

A basic goal in the time-domain scheduling of uplink transmissions is to achieve multi-user diversity among simultaneous users using common radio resources. For example, the Node-B may measure, as the predetermined factor, a channel quality indicator (CQI) per subcarrier block, (i.e., a localized or distributed subcarrier block), on uplink transmissions from the WTRUs and performs time-domain scheduling of the uplink transmissions based on the CQIs. The Node-B schedules uplink transmissions of WTRUs in different time positions, (i.e., sub-frames), depending on the predetermined factors. However, frequency positions of WTRU's transmissions are fixed.

The CQI may be measured by using any conventional methods. It should be noted that other relevant channel dependent factors may be used as the predetermined factor. Optionally, the Node-B may perform frequency and/or time hopping in scheduling uplink transmissions to average interference from neighboring cells (step 210).

If it is determined at step 204 that the QoS requirement is low, the Node-B selects a small bandwidth subcarrier block (step 212). The Node-B then schedules uplink transmissions of the WTRUs in a frequency-domain and/or time-domain based on a predetermined factor (step 214). The Node-B schedules uplink transmissions of WTRUs in different time positions or different frequency positions, (i.e., subcarriers), depending on the predetermined factors. Since there is not enough frequency diversity provided by the small bandwidth subcarrier block, frequency-domain scheduling will improve performance over the signaling overhead. Based on CQIs of different WTRUs at different subcarrier blocks and other factors, the Node-B schedules the uplink transmissions of the WTRUs in frequency-domain and/or time-domain.

Alternatively, the Node-B may apply frequency and/or time hopping to achieve better frequency and time diversity and to average interference from neighboring cells (step 214).

The Node-B signals scheduling information to the WTRU for its uplink transmissions. The scheduling information includes, but is not limited to, a location of the assigned subcarrier block(s) and bandwidth of the assigned subcarrier block(s), a modulation scheme for each subcarrier block or transmission time interval (TTI), a transport block size, the number of information bits for each subcarrier block or TTI, and a coding rate. The coding rate may be derived from the modulation scheme, the number of allocated subcarrier blocks and the transport block size.

FIG. 3 is a block diagram of a Node-B 300. The Node-B 300 includes a scheduling request processing unit 302 and a scheduling unit 304. The scheduling request processing unit 302 processes a scheduling request received from a WTRU. The scheduling unit 304 then selects a subcarrier block having a certain bandwidth for the WTRU based on a QoS requirement of the WTRU and schedules uplink transmissions of the WTRU based on a predetermined factor.

Additionally, the scheduling may be performed by the WTRU or scheduling information may be sent to the Node-B by the WTRU. For WTRU scheduling, the scheduling unit 304 would be present in the WTRU and a scheduling unit may also be present in the Node-B.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a single carrier frequency division multiple access (SC-FDMA) system including a wireless transmit/receive unit (WTRU) and a Node-B, a method for scheduling uplink transmissions, the method comprising:
a Node-B receiving a scheduling request from a WTRU;
the Node-B selecting at least one subcarrier block having a certain bandwidth for the WTRU based on quality of service (QoS) requirement of the WTRU; and
the Node-B scheduling uplink transmissions of the WTRU based on a predetermined factor.

2. The method of claim 1 wherein the Node-B selects at least one subcarrier block having a large bandwidth if the QoS requirement of the WTRU is high.

3. The method of claim 2 wherein the QoS requirement is a data rate requirement.

4. The method of claim 2 wherein the Node-B schedules the uplink transmissions of the WTRU in a time-domain based on the predetermined factor.

5. The method of claim 4 wherein the Node-B performs frequency hopping in scheduling the uplink transmissions.

6. The method of claim 4 wherein the Node-B performs time hopping in scheduling the uplink transmissions.

7. The method of claim 1 wherein the Node-B selects at least one subcarrier block having a small bandwidth if the QoS requirement of the WTRU is low.

8. The method of claim 7 wherein the Node-B schedules the uplink transmissions of the WTRU in at least one of time-domain and frequency-domain based on the predetermined factor.

9. The method of claim 7 wherein the Node-B performs frequency hopping in scheduling the uplink transmissions.

10. The method of claim 7 wherein the Node-B performs time hopping in scheduling the uplink transmissions.

11. The method of claim 1 wherein the Node-B schedules the uplink transmissions based on a measured channel quality indicator (CQI).

12. The method of claim 11 wherein the CQI is measured per subcarrier block.

13. The method of claim 1 further comprising:
the Node-B signaling scheduling information to the WTRU for uplink transmissions.

14. The method of claim 13 wherein the scheduling information includes at least one of a location of an assigned subcarrier block, a bandwidth of the assigned subcarrier block, a modulation scheme for the assigned subcarrier block, a modulation scheme during a transmission time interval (TTI), a transport block size, the number of information bits for the subcarrier block, the number of information bits during a TTI, and a coding rate.

15. A Node-B for scheduling uplink transmissions in a single carrier frequency division multiple access (SC-FDMA) system, the Node-B comprising:
a scheduling request processing unit for processing a scheduling request received from a wireless transmit/receive unit (WTRU); and
a scheduling unit configured to select at least one subcarrier block having a certain bandwidth for the WTRU based on a quality of service (QoS) requirement of the WTRU and schedule uplink transmissions of the WTRU based on a predetermined factor.

16. The Node-B of claim 15 wherein the scheduling unit is configured to select at least one subcarrier block having a large bandwidth if the QoS requirement of the WTRU is high.

17. The Node-B of claim 16 wherein the QoS requirement is a data rate requirement.

18. The Node-B of claim 16 wherein the scheduling unit is configured to schedule the uplink transmissions of the WTRU in a time-domain based on the predetermined factor.

19. The Node-B of claim 18 wherein the scheduling unit is configured to perform frequency hopping in scheduling the uplink transmissions.

20. The Node-B of claim 18 wherein the scheduling unit is configured to perform time hopping in scheduling the uplink transmissions.

21. The Node-B of claim 15 wherein the scheduling unit is configured to select at least one subcarrier block having a small bandwidth if the QoS requirement of the WTRU is low.

22. The Node-B of claim 21 wherein the scheduling unit is configured to schedule the uplink transmissions of the WTRU in at least one of time-domain and frequency-domain based on the predetermined factor.

23. The Node-B of claim 21 wherein the scheduling unit is configured to perform frequency hopping in scheduling the uplink transmissions.

24. The Node-B of claim 21 wherein the scheduling unit is configured to perform time hopping in scheduling the uplink transmissions.

25. The Node-B of claim 15 wherein the scheduling unit is configured to schedule the uplink transmissions based on a measured channel quality indicator (CQI).

26. The Node-B of claim 25 wherein the CQI is measured per subcarrier block.

27. The Node-B of claim 15 wherein the scheduling unit is configured to signal scheduling information to the WTRU for uplink transmissions.

28. The Node-B of claim 27 wherein the scheduling information includes at least one of a location of an assigned subcarrier block, a bandwidth of the assigned subcarrier block, a modulation scheme for the assigned subcarrier block, a modulation scheme during a transmission time interval (TTI), a transport block size, the number of information bits for the subcarrier block, the number of information bits during a TTI, and a coding rate.

29. A wireless transmit/receive unit (WTRU) communicating using single carrier frequency division multiple access (SC-FDMA), the WTRU comprising:
a scheduling unit configured to provide at least one subcarrier block having a certain bandwidth for the WTRU based on quality of service (QoS) requirement of the WTRU and to schedule uplink transmissions of the WTRU based on a predetermined factor.

30. The WTRU of claim 29 wherein the scheduling unit is configured to select at least one subcarrier block having a large bandwidth if the QoS requirement of the WTRU is high.

31. The WTRU of claim 30 wherein the QoS requirement is a data rate requirement.

32. The WTRU of claim 30 wherein the scheduling unit is configured to schedule the uplink transmissions of the WTRU in a time-domain based on the predetermined factor.

33. The WTRU of claim 32 wherein the WTRU is configured to perform frequency hopping in scheduling the uplink transmissions.

34. The WTRU of claim 32 wherein the scheduling unit is configured to perform time hopping in scheduling the uplink transmissions.

35. The WTRU of claim 29 wherein the scheduling unit is configured to select at least one subcarrier block having a small bandwidth if the QoS requirement of the WTRU is low.

36. The WTRU of claim 35 wherein the WTRU is configured to schedule the uplink transmissions in at least one of time-domain and frequency-domain based on the predetermined factor.

37. The WTRU of claim 35 wherein the scheduling unit is configured to perform frequency hopping in scheduling the uplink transmissions.

38. The WTRU of claim 35 wherein the scheduling unit is configured to perform time hopping in scheduling the uplink transmissions.

39. The WTRU of claim 29 wherein the scheduling unit is configured schedule the uplink transmissions based on a measured channel quality indicator (CQI).

40. The WTRU of claim 39 wherein the CQI is measured per subcarrier block.

41. The WTRU of claim 29 wherein the WTRU is configured to signal scheduling information to the Node-B for uplink transmissions.

42. The WTRU of claim 41 wherein the WTRU is configured such that the scheduling information includes at least one of a location of an assigned subcarrier block, a bandwidth of the assigned subcarrier block, a modulation scheme for the assigned subcarrier block, a modulation scheme during a transmission time interval (TTI), a transport block size, the number of information bits for the subcarrier block, the number of information bits during a TTI, and a coding rate.
